(19) United States
(12) Patent Application Publication
(10) Pub. No.: US 2005/0254614 A1
(43) Pub. Date: Nov. 17, 2005

(54) Method and apparatus for measuring wall thickness of a vessel

(76) Inventor: Kevin Scott McKinny, Irvine, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/078,688

(22) Filed: Mar. 11, 2005

Related U.S. Application Data
(60) Provisional application No. 60/552,882, filed on Mar. 11, 2004.

(51) Int. Cl. G21G 1/06

(52) U.S. Cl. 376/159

(57) ABSTRACT

A method measures a thickness of a wall. The method includes irradiating at least a portion of the wall with a plurality of 14-MeV neutrons. The wall emits gamma rays with photon energies characteristic of the atomic nuclei in response thereto. The method further includes detecting at least a portion of the gamma rays emitted from the wall and measuring the photon energies of the detected gamma rays with an energy resolution better than approximately 0.5%. The detected gamma rays have a first range of photon energies. The method further includes selecting a second range of photon energies which is a subset of the first range of photon energies. The method further includes calculating a number of detected gamma rays having measured photon energies within the selected second range of photon energies. The method further includes determining the wall thickness using the calculated number of detected gamma rays.

### CLAIM OF PRIORITY

This application claims the benefit of U.S. Provisional Patent Application No. 60/552,882, filed Mar. 11, 2004, which is incorporated in its entirety by reference herein.

### BACKGROUND OF THE INVENTION

1. Field of the Invention

The present invention relates generally to methods and apparatus for measuring wall thickness of a structure, and more specifically, to methods and apparatus for measuring wall thickness of a fluid-containing vessel, such as oil pipelines and cracking towers in the petroleum industry.

2. Description of the Related Art

Many industries deal with fluid transfer of a gas or liquid from one point to another by using tubular conduits of varying sizes, lengths, and diameters. Furthermore, many industries also deal with storage or treatment of fluids in containers. These tubular conduits or containers (or more generally, fluid-containing vessels) occasionally develop internal weak points that may be caused by the fluid itself dissolving, wearing, or breaking away portions of the inside surface of the vessel walls. In this way, portions of the walls can experience thinning or weakening. The weaker, thin-walled portions of the vessel walls can occasionally experience a sudden and catastrophic total perforation without any advance notice, thereby allowing the fluid contents to flow freely and undesirably from the vessel, causing substantial loss of valuable fluid and very likely great damage to the surrounding area.

For example, the petroleum industry commonly uses relatively large above-ground oil pipelines of approximately 10 to 12 feet in diameter with concrete/cement composite walls of 2 to 3 inches in thickness to transport large quantities of hot, fluid oil under pressure. Under these conditions, a portion of the wall of the pipeline is found to occasionally erode away, thereby causing a weakened area that can eventually erode completely into a catastrophic rupture causing great and costly loss of the hot fluid oil, as well as significant damage to the surrounding environment. Similarly, a distillation process is used to refine raw petroleum in containers called “cracking towers,” the walls of which may weaken and rupture due to erosion from inside the walls.

### SUMMARY OF THE INVENTION

In certain embodiments, a method measures a thickness of a wall. The method comprises irradiating at least a portion of the wall with a plurality of 14-MeV neutrons. The wall emits gamma rays with photon energies characteristic of the atomic nuclei in response thereto. The method further comprises detecting at least a portion of the gamma rays emitted from the wall and measuring the photon energies of the detected gamma rays with an energy resolution better than approximately 0.5%. The detected gamma rays have a first range of photon energies. The method further comprises selecting a second range of photon energies which is a subset of the first range of photon energies. The method further comprises calculating a number of detected gamma rays having measured photon energies within the selected second range of photon energies. The method further comprises determining the wall thickness using the calculated number of detected gamma rays.

In certain embodiments, a method measures a thickness of a wall. The method comprises irradiating at least a portion of the wall with a plurality of neutrons. The wall emits gamma rays with photon energies characteristic of the atomic nuclei in response thereto. The method further comprises detecting at least a portion of the gamma rays emitted from the wall and measuring the photon energies of the detected gamma rays. The detected gamma rays have a first range of photon energies. The method further comprises selecting a second range of photon energies which is a subset of the first range of photon energies. The method further comprises calculating a number of detected gamma rays having measured photon energies within the selected second range of photon energies. The method further comprises determining the wall thickness using the calculated number of detected gamma rays.

In certain embodiments, a method measures a thickness of a wall. The method comprises positioning a source of neutrons in proximity to the wall. The method further comprises directing the neutrons at the wall. The neutrons cause the wall to emit gamma rays with photon energies characteristic of atomic nuclei within the wall. The method further comprises detecting at least a portion of the gamma rays. The method further comprises determining a photon energy distribution of the detected gamma rays. The method further comprises calculating the thickness of the wall from a subset of the photon energy distribution of the detected gamma rays.

### BRIEF DESCRIPTION OF THE DRAWINGS

FIG. 1 schematically illustrates an exemplary apparatus for measuring the thickness of a wall in accordance with embodiments described herein.

FIG. 2 schematically illustrates an exemplary source comprising a charged particle accelerator in accordance with certain embodiments described herein.

FIG. 3 is a flowchart of an exemplary method of measuring a thickness of a wall in accordance with embodiments described herein.

FIG. 4 is a plot of a delayed gamma ray energy spectrum (number of delayed gamma rays as a function of photon energy) for irradiation of an exemplary concrete wall of an oil pipeline in accordance with embodiments described herein.

FIG. 5 is a plot of the number of counts per second due to delayed gamma rays in the 846 keV peak as a function of the wall thickness.

FIG. 6 schematically illustrates an analyzer compatible with embodiments described herein.

FIG. 7A schematically illustrates a filtered peak separated into one peak bandwidth and two shoulder bandwidths.

FIG. 7B schematically illustrates background subtraction from the peaks of the filtered signal.

FIG. 8 schematically illustrates electronic processing of the gamma ray signals to effectively reduce the response time constant.

### DETAILED DESCRIPTION OF EXEMPLARY EMBODIMENTS

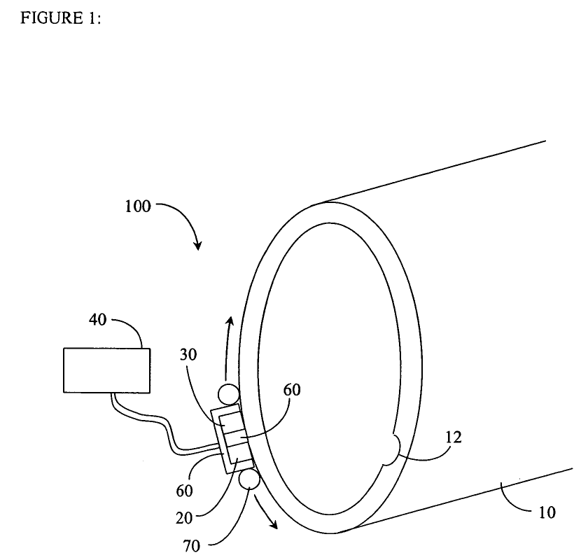

FIG. 1 schematically illustrates an exemplary apparatus 100 for measuring the thickness of a wall 10 in accordance with embodiments described herein. The apparatus comprises a source 20 of a plurality of neutrons 14 which irradiate at least a portion of the wall 10 comprising atomic nuclei. In response to the neutron irradiation, the irradiated portion of the wall 10 emits gamma rays with photon energies characteristic of the atomic nuclei. The apparatus 100 further comprises at least one gamma ray detector 30 which detects at least a portion of the gamma rays emitted from the wall 10 and which measures the photon energies of the detected gamma rays. The gamma ray detector 30 generates signals indicative of the detected gamma rays and their photon energies. The apparatus 100 further comprises an analyzer 40 which filters the signals from the gamma ray detector 30 to pass signals corresponding to at least a portion of the photon energies characteristic of the atomic nuclei of the wall 10 and to exclude signals not corresponding to photon energies characteristic of the atomic nuclei of the wall 10.

As schematically illustrated by FIG. 1, the wall 10 of certain embodiments has a thinned portion or depression 12 which represents a weakened portion of the wall 10. Exemplary materials for the wall 10 include, but are not limited to, cement, concrete, brick, stainless steel, or a combination of these materials. Other materials are also compatible with embodiments described herein. In certain embodiments, the wall 10 comprises a portion of an oil pipeline, a hearth-wall liner of an iron-smelting blast furnace, or other types of fluid-containing vessels (e.g., containers or conduits) for which it is desirable to provide external detection of thinned regions before these thinned regions become weak and possibly experience a catastrophic rupture. Certain embodiments described herein are used to measure the thickness of any wall 10 of any known composition. For example, certain embodiments are used to determine the thickness of a wall 10 of a sealed concrete bunker containing people, contraband, explosives, chemical or biological weapons, or radioactive materials. Upon knowing the thickness of the wall 10, the amount of explosive charge used to blast open the wall 10 without damaging its contents can be calculated.

In certain embodiments, the apparatus 100 is positioned outside or external to the volume defined by the wall 10, while in other embodiments, the apparatus 100 is positioned inside or internal to the volume defined by the wall 10. More generally, in certain embodiments, the apparatus 100 is used to measure the thickness of structural elements, including but not limited to, walls.

Various types of sources 20 of neutrons 14 are compatible with embodiments described herein. In certain embodiments, the source 20 comprises a radioisotope material which emits neutrons 14 to irradiate the portion of the wall 10 under study. Exemplary radioactive materials compatible with certain embodiments described herein include, but are not limited to, californium-252 (Cf-252) which generates neutrons 14 having energies of up to approximately 10 MeV with an average energy of approximately 2 MeV, americium-beryllium (Am—Be) compound isotopic source material which generates neutrons 14 having energies of up to approximately 10 MeV with an average energy of approximately 2 MeV, radium-beryllium (Ra—Be) compound isotopic source material, plutonium-beryllium (Pu—Be) compound isotopic source material, and curium-beryllium (Cm—Be) compound isotopic source material.

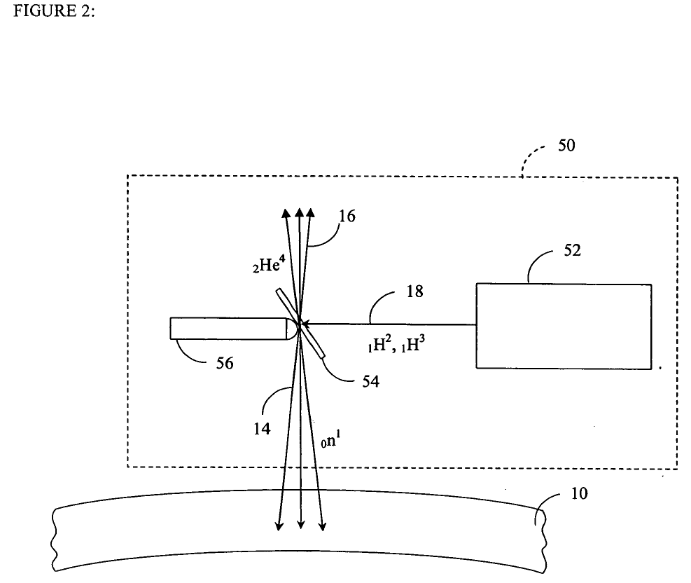

In certain other embodiments, the source 20 comprises an accelerator subsystem 50 which generates neutrons 14, as schematically illustrated by FIG. 2. The accelerator subsystem 50 comprises a charged particle accelerator 52 which accelerates ionized isotopes of hydrogen 18 (e.g., deuterium ₁H², tritium ₁H³, or both deuterium and tritium) towards a target 54. In certain embodiments, the accelerated ions 18 propagate in a vacuum from the accelerator 52 to the target 54. In certain embodiments, the energy of the incident deuterium and/or tritium ions 18 is sufficient to overcome the coulombic repellent force between the ions 18 and the positively charged nuclei of the target 54. Energies of the accelerated deuterium and/or tritium ions 18 which are greater than approximately 0.05 MeV are used in certain embodiments, but other energies may also be used. In certain embodiments, the source 20 comprises a “D-T generator” in which the target 54 comprises tritium impinged by deuterium ions from the accelerator 52 or a target 54 comprising deuterium impinged by tritium ions from the accelerator 52. Such embodiments produce neutrons with approximately 14.11 MeV. In certain other embodiments, the source 20 comprises a “D-D generator” in which the target 54 comprises deuterium impinged by deuterium ions from the accelerator 52. Such embodiments produce neutrons with approximately 2.45 MeV. Exemplary charged particle accelerators 52 compatible with embodiments described herein are available from Thermo MF Physics Corporation of Colorado Springs, Colo. (e.g., Model MP320 accelerator), although other charged particle accelerators 52 are also compatible with embodiments described herein.

In certain embodiments, the charged particle accelerator 52 is operated in a continuous direct current (DC) mode such that the deuterium and/or tritium ions 18 are substantially continually incident on the target 54, producing a substantially continuous (e.g., non-pulsed) flux of neutrons 14. In certain embodiments, the accelerated deuterium and/or tritium ions 18 are modulated into “long” discrete time intervals (e.g., 0.1 second to 10 seconds). In the present context, the term “long” is used with respect to the coincidence resolving times described later herein, which are on the order of 1 to 100 nanoseconds.

In certain embodiments, the target 54 comprises a scandium tritide layer deposited on a copper substrate. Scandium tritide comprises tritium nuclei which, when irradiated by the incident deuteron and/or tritium ions 18, generate a stream of neutrons 14 (neutrally charged nucleons, signified by ₀n¹) and alpha particles 16 (ionized helium nuclei, signified by ₂He⁴) according to the following exemplary reactions:
₁H²+₁H³→₂He⁴+ₒn¹(14 MeV)
₁H²+₁H²→₂He³+ₒn¹(2.45 MeV)
₁H³+₁H³→₂He⁴+ₒn¹+ₒn¹+11.33 MeV
Other types of targets 44 and materials are also compatible with embodiments described herein.

In certain embodiments in which deuterium ions 18 from the accelerator 52 impinge the target 54 containing tritium, upon being irradiated by the deuterium ions 18, the target 54 generates neutrons 14 and alpha particles 16 which simultaneously, in pairs, propagate from the target 54 in substantially opposite directions, as schematically illustrated by FIG. 2. As is described more fully below, in certain embodiments, at least a portion of the alpha particles 16 are detected and used to provide spatial information regarding the direction of propagation of the corresponding neutrons 14. While neutrons 14 and alpha particles 16 are generated from the target 54 in certain embodiments, other subatomic particles or emissions with desirable properties may also feasibly be used in other embodiments.

In certain embodiments, the target 54 is fixed in relation to the beam of incident hydrogen isotopes 18, while in other embodiments, the target 54 is independently steerable or adjustable relative to the hydrogen isotope beam 18 and the wall 10. An electro-mechanical positioning device 56, either manually controlled or automatically controlled may be used in certain embodiments to adjust the orientation or position of the target 54 relative to the incident hydrogen isotope beam 18. Persons skilled in the art can select an appropriate electromechanical positioning device 56 compatible with embodiments described herein.

Certain embodiments irradiate the portion of the wall 10 with approximately 10⁸ neutrons per second, with the neutrons 14 having energies of approximately 14 MeV. Such 14-MeV neutrons have desirable scattering properties (i.e., inelastic scattering with nuclei) and have the ability to penetrate significant thicknesses of the wall 10. For example, in certain embodiments, the 1/e interaction length of the 14-MeV neutrons is up to approximately 50 centimeters. Furthermore, the cross sections (in millibarns) for gamma ray production in various atomic nuclei of interest (e.g., aluminum or maganese) by 14-MeV neutrons is nearly independent of the neutron energy at that energy level. Therefore, in certain embodiments, the relative concentrations of these atomic nuclei can be obtained to a high degree of accuracy without knowing the actual collision energy. This is in contrast to lower neutron energies, which have cross-sections which vary much more significantly with neutron energy, thereby making it much more difficult to calculate the relative chemical concentrations of different chemical elements without knowledge of the precise collision energy. Despite these considerations, however, other neutron energies besides approximately 14 MeV (and even multiple energy levels) may be used in accordance with embodiments described herein.

At least a portion of the wall 10 is exposed to the flux of neutrons 14 generated by the source 20, and the neutrons 14 penetrate the wall 10 and interact with the atomic nuclei (e.g., aluminum or maganese nuclei) within the wall 10. Through a process termed “fast neutron activation” or FNA, an atomic nucleus of the wall 10 is excited by a fast neutron 14 which loses energy to the nucleus. The term “fast” is used herein to label neutrons 14 having kinetic energies which are larger than the kinetic energies of thermal neutrons, typically fractions of an electron-volt (e.g., 0.025 eV). The fast neutron activation thereby causes the atomic nucleus to become an unstable nucleus which substantially immediately emits a gamma ray, as expressed by: n+N→n+N* and N*→N+γ, where a neutron (n) excites the nucleus (N), yielding a new unstable nucleus (N*), which emits a gamma ray (γ). The gamma rays have discrete photon energies which are characteristic of the atomic nuclei activated by the neutrons. For example, when irradiated by 14-MeV neutrons, carbon nuclei emit gamma rays having photon energies of approximately 4.44 MeV.

In certain embodiments, a slow or “thermal” neutron is captured by the nucleus, as expressed by: n+N→N′+γ, where a neutron (n) is absorbed by the nucleus (N), yielding a new nucleus (N′) which has one more neutron than does the original nucleus. The new nucleus emits a “prompt neutron-capture” gamma ray (γ) in response. This emission of a gamma ray is sometimes termed as “prompt” gamma emission because it occurs nearly immediately upon the absorption of the nucleus. Typically, once a neutron is thermalized (that is, its energy is reduced down to thermal levels from its initial energy), the neutron is not captured by a nucleus until after a couple of hundred microseconds. Thus, there is typically a delay of a couple of hundred microseconds between the arrival of the neutron and the emission of the “prompt neutron-capture” gamma ray.

Subsequently, in certain embodiments in which the new nucleus is a radioactive isotope, the new nucleus decays with a rate determined by its characteristic half-life to another isotope, as expressed by: N′→N″+ν+γ+e, where the new nucleus (N′) decays after some time delay to a nucleus (N″), sometimes referred to as a “daughter” nucleus, via emission of a neutrino (ν), a gamma ray (γ) and an electron (e⁻) or a positron (e⁺). The time delay for this decay of the new nucleus to the daughter nucleus is unique to the particular new nucleus. This emission of a gamma ray is sometimes termed as “delayed nuclear-decay” gamma emission because it occurs after a time delay with respect to the initial activation of the nucleus. In certain embodiments, the gamma rays emitted in this delayed decay reaction have discrete photon energies which are characteristic of the atomic nuclei which absorbed the neutrons.

For example, in certain embodiments, aluminum-27 (Al-27 or Al²⁷) nuclei are activated by incident neutrons, as expressed by: n+Al²⁷→Al²⁸+γ. The Al-28 that is produced is an unstable isotope of aluminum, and it decays (by emission of a gamma ray and an electron and a neutrino) with a half-life of approximately 2.24 minutes. The delayed nuclear-decay gamma rays (with energies of approximately 1779 keV) are observed in certain embodiments several minutes after the initial neutron capture occurs.

In certain embodiments, at least some of the fast neutrons 14 from the source 20 undergo multiple inelastic scattering events within the wall 10 prior to being absorbed by an atomic nucleus of the wall 10. By losing energy during these inelastic scattering events, the neutrons are slowed to thermal energy levels, and are said to be moderated or thermalized. In certain embodiments, thermal neutrons are considered to be those neutrons with a total kinetic energy level substantially less than those of the incident fast neutrons. For example, thermal neutrons may have energies on the order of 0.025 eV, while the fast neutrons may have energies on the order of 14 MeV. The thermalized neutrons subsequently interact with the atomic nuclei of the wall 10 with comparatively large thermal neutron scattering cross-sections, and producing a series of discrete delayed gamma ray emission peaks characteristic of the atomic nuclei of the wall 10. Typically, materials which are rich in hydrogen and carbon atoms are good “moderators” of the fast neutrons.

Certain embodiments advantageously produce the thermal neutrons within the wall 10. The thermal neutron flux within the wall 10 of certain such embodiments is larger than that produced by prior systems which generate thermal neutrons in a separate moderator near the wall 10. In such prior systems, because thermal neutrons have a relatively small penetration depth (e.g., approximately 2-3 centimeters), only a small fraction of the wall 10 is irradiated by the thermal neutrons from the separate modulator. Thus, using a separate modulator can necessitate either a very high incident neutron flux, or very long counting/integration times.

In contrast, by not using a separate modulator and instead thermalizing the neutrons within the wall 10, certain embodiments described herein generate effectively all the thermal neutrons within the wall 10. A larger fraction of the wall 10 is irradiated by the thermal neutrons because the fast neutrons have a relatively large penetration depth (e.g., approximately 0.5-1 meter). In this way, certain embodiments advantageously increase the thermal neutron flux within the wall 10, thereby increasing the gamma ray count rate and system efficiency.

At least a portion of the gamma rays emitted by the wall 10 are detected in certain embodiments by one or more gamma ray detectors 30 which also measure the photon energies of the detected gamma rays. The gamma ray detector 30 generates signals indicative of the detected gamma rays and their photon energies. One or more gamma ray detectors 30 are placed relative to the portion of the wall 10 being examined to detect these emitted gamma rays and their energies. The detected gamma rays and their corresponding energies are subsequently analyzed to measure the thickness of the portion of the wall 10 being studied.

In certain embodiments, the at least one gamma ray detector 30 comprises a solid-state gamma ray detector having high energy resolution. Exemplary gamma ray detectors 30 compatible with embodiments described herein include, but are not limited to, high-purity (80%) N-type (neutron-resistant) germanium solid-state detectors (available from ORTEC Corp. of Oak Ridge, Tenn.), xenon high-resolution gamma ray detectors, and other high-energy-resolution gamma ray detectors. In certain embodiments, the gamma ray detector 30 has an energy resolution better than approximately 0.5%, while in other embodiments, the gamma ray detector 30 has an energy resolution better than approximately 0.1%.

In certain embodiments, the solid-state gamma ray detectors 30 advantageously provide the ability to resolve gamma ray energies precisely (e.g., with energy resolution better than approximately 0.5%, typically approximately 0.1% to approximately 0.3%) and the ability to temporally resolve gamma ray events (e.g., with temporal resolution better than approximately 3 nanoseconds). Such high energy resolution is not provided by scintillation detectors (e.g., sodium iodide), which have an energy resolution between approximately 6% and 10%.

In certain embodiments, the apparatus 100 further comprises an analyzer 40 electrically coupled to the gamma ray detector 30. The analyzer 40 receives the signals generated by the gamma ray detector 30 which are indicative of the detected gamma rays and their photon energies. The analyzer 40 of certain embodiments comprises a computer and other electronics (e.g., filters, coincidence circuits, analog-to-digital converters, discriminators, gates, digital signal processors, etc.) for receiving and processing the signals from the gamma ray detector 30. As described more fully below, by processing these signals indicative of the detected gamma rays and their photon energies, the analyzer 40 of certain embodiments measures the thickness of the irradiated portion of the wall 10.

In certain embodiments, neutron absorbing or moderating material 60 (e.g., borated polyethylene) is placed between the source 20 and the gamma ray detector 30 to shield the gamma ray detector 30 from neutrons, as schematically illustrated by FIG. 1. In addition, certain embodiments include such neutron absorbing or moderating material 60 in locations surrounding the source 20 to shield personnel and surrounding equipment from the neutrons. In certain embodiments, such neutron absorbing or moderating material is positioned so as to collimate the neutrons propagating from the source 20 to the wall 10. Certain other embodiments include additional shielding material to protect personnel and surrounding equipment from deuterons, alpha particles, or gamma rays generated by the apparatus 100.

In certain embodiments, the source 20 and the gamma ray detector 30 are movable to various positions relative to the wall 10 so as to scan for thinned portions or depressions 12. For example, in certain embodiments, the source 20 and the gamma ray detector 30 are on a movable platform 70 which traverses the circumference of the wall 10 (shown by arrows in FIG. 1). In other embodiments, the source 20 is movable along a circumference of the wall 10 while the gamma ray detector 30 remains relatively fixed in position. The source 20 and the gamma ray detector 30 of certain embodiments also traverse the length of the wall 10, thereby analyzing the full periphery of the wall 10.

In certain embodiments, the source 20 and the gamma ray detector 30 are positioned on the same side of the wall 10. In certain embodiments, the source 20 and the gamma ray detector 30 of certain embodiments are positioned outside the volume defined by the wall 10. Certain such embodiments advantageously provide a method and apparatus for determining the wall thickness from outside the wall 10. In certain other embodiments, the source 20 and the gamma ray detector 30 are positioned inside the volume defined by the wall 10. In still other embodiments, the source 20 and the gamma ray detector 30 are positioned on different sides of the wall 10. For example, the source 20 is positioned outside the volume defined by the wall 10 and the gamma ray detector 30 is positioned inside the volume defined by the wall 10. In an alternative example, the source 20 is positioned inside the volume defined by the wall 10 and the gamma ray detector 30 is positioned outside the volume defined by the wall 10.

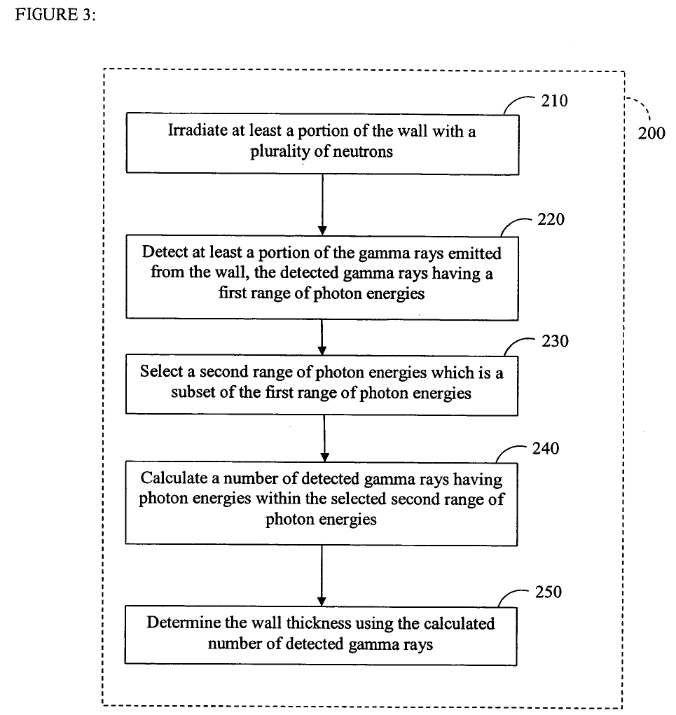

FIG. 3 is a flowchart of an exemplary method 200 of measuring a thickness of a wall 10 in accordance with embodiments described herein. In an operational block 210, the method 200 comprises irradiating at least a portion of the wall 10 with a plurality of neutrons. In response to being irradiated by the neutrons, the wall 10 emits gamma rays with photon energies characteristic of the atomic nuclei. In an operational block 220, the method 200 further comprises detecting at least a portion of the gamma rays emitted from the wall 10 and measuring the photon energies of the detected gamma rays. The detected gamma rays have a first range of photon energies. In an operational block 230, the method 200 further comprises selecting a second range of photon energies which is a subset of the first range of photon energies. In an operational block 240, the method further comprises calculating a number of detected gamma rays having measured photon energies within the selected second range of photon energies. In an operational block 250, the method 200 further comprises determining the wall thickness using the calculated number of detected gamma rays.

In certain embodiments, irradiating at least a portion of the wall 10 with a plurality of neutrons, as indicated by the operational block 210 of FIG. 3, comprises generating the plurality of neutrons and directing the neutrons toward the wall 10. The neutrons of certain embodiments have energies of approximately 14 MeV, but other neutron energies are also compatible with embodiments described herein. The irradiation time during which the portion of the wall 10 is being irradiated is selected in certain embodiments depending on the decay half-life of the isotope being used. In certain embodiments, the irradiation time is up to several minutes (e.g., between approximately 1 minute and approximately 5 minutes), while in other embodiments, the irradiation time is up to approximately 10 minutes, or even longer.

In certain embodiments, detecting at least a portion of the gamma rays emitted from the wall 10, as indicated by the operational block 220 of FIG. 3, comprises detecting gamma rays from delayed nuclear-decay processes. In certain such embodiments, the gamma rays are detected concurrently with the irradiation of the wall 10 by the neutrons. In certain such embodiments, the gamma ray detector 30 is in proximity to the wall 10 at substantially the same time that the source 20 is in proximity to the wall 10. Under such conditions, the gamma ray detector 30 can experience radiation damage due to neutron irradiation from the source 20 as well as a large background contribution due to neutrons interacting within the detector 30.

In certain embodiments, the delayed nuclear-decay gamma rays are emitted by the irradiated portion of the wall 10 for up to several minutes after the irradiation. In certain embodiments in which the delayed nuclear-decay gamma rays are detected after the neutron irradiation of the wall 10, the gamma ray detector 30 can be spaced away from the source 20 which is in proximity to the wall 10 during the irradiation of the wall 10, and then the gamma ray detector 30 can be placed in proximity to the wall 10 while the source 20 is turned off or spaced away from the gamma ray detector 30 during the detection of the gamma rays. Such embodiments advantageously reduce the possibility of radiation damage to the gamma ray detector 30 due to neutron irradiation from the source 20.

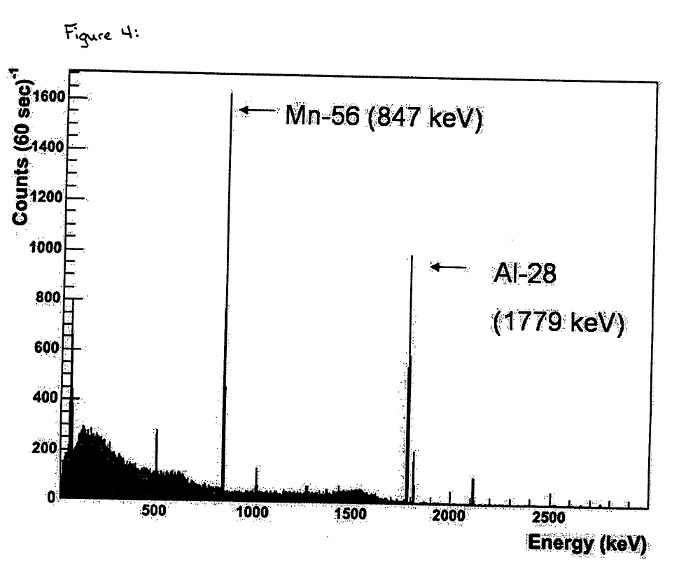

FIG. 4 is a plot of a delayed gamma ray energy spectrum (number of delayed gamma rays as a function of photon energy) for irradiation of an exemplary concrete wall 10 of an oil pipeline in accordance with embodiments described herein. The delayed gamma ray energy spectrum of FIG. 4 has a first range of photon energies from approximately 0 to approximately 2.1 MeV and comprises a number of peaks, each of which has an energy which is characteristic of the atomic nuclei of the wall 10. For example, the peak at approximately 511 keV (0.511 MeV) is characteristic of annihilation of positrons that are produced in the decay of many isotopes, the peak at approximately 846 keV (0.846 MeV) is characteristic of the decay of maganese-56 (Mn-56) nuclei produced when neutrons are captured by maganese-55 (Mn-55) nuclei, and the peak at approximately 1779 keV (1.779 MeV) is characteristic of the decay of aluminum-28 nuclei produced when neutrons are captured by aluminum-27 nuclei, as described above.

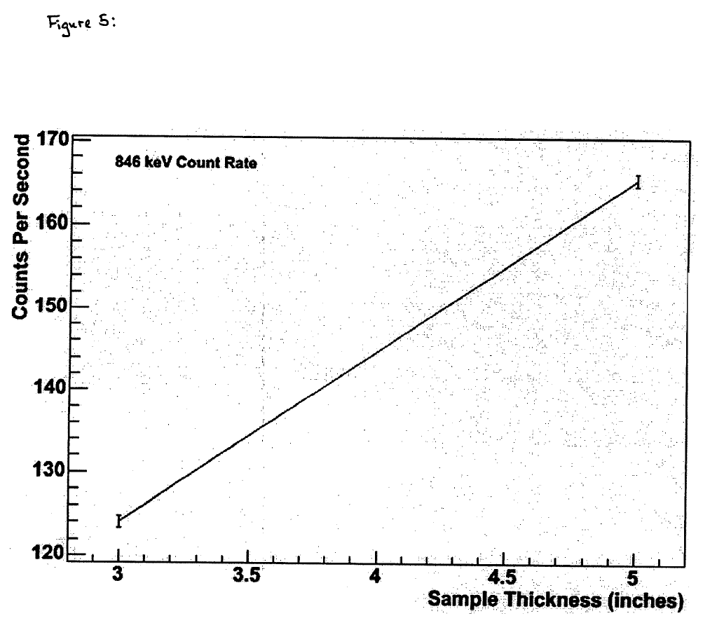

In certain embodiments, the number of delayed gamma rays in at least one peak of the gamma ray energy spectrum is determined by the analyzer 40. The number of delayed gamma rays in a given energy peak is proportional to the number of nuclei which emitted the gamma rays with that specific energy. For example, FIG. 5 is a plot of the number of counts per second of delayed gamma rays in the 846 keV peak (corresponding to maganese-56 nuclei) as a function of the wall thickness. As the wall thickness increases, the number of maganese-55 nuclei present in the irradiated portion of the wall 10 increases, and through interactions with the neutrons, the number of maganese-56 nuclei increases, thereby increasing the number of delayed gamma rays in the 846 keV peak. Thus, the number of delayed gamma rays in a given energy peak provides a measure of the amount of wall material which is irradiated by the neutrons.

In certain embodiments, samples of known thicknesses with the same composition as the wall 10 under examination are irradiated with neutrons, and the detected delayed gamma rays are used to calibrate the number of delayed gamma rays in a given energy peak to wall thickness. In certain embodiments, the number of detected gamma rays are calibrated to the thickness so as to account for non-linearities caused by attenuation of the gamma rays in the wall 10. In certain other embodiments, the non-linearities are calculated using known properties of the wall 10. As described more fully below, in certain embodiments, the analyzer 40 determines the number of counts per second detected within a selected photon energy range corresponding to at least one gamma ray spectral peak, while in other embodiments, the analyzer 40 performs a time integration of the number of counts detected within a selected time window within a selected photon energy range corresponding to at least one gamma ray spectral peak.

In certain embodiments, a second range of photon energies is selected which is a subset of the first range of photon energies, as indicated by the operational block 230 of FIG. 3. As described more fully below, in certain embodiments, the selected second range of photon energies is used to select portions of the energy spectrum of the detected gamma rays for further analysis. The second range of photon energies of certain embodiments comprises gamma ray energies which are within a predetermined range of gamma ray energy peaks which are characteristic of one or more atomic nuclei of the wall 10. For example, for certain embodiments in which the wall 10 comprises concrete, the second range of photon energies is selected to be ±10 keV relative to the delayed nuclear-decay gamma ray energy corresponding to aluminum-28 nuclei. In other embodiments in which the wall 10 comprises concrete, the second range of photon energies is selected to be ±10 keV relative to the delayed nuclear-decay gamma ray energy corresponding to maganese-56 nuclei. In certain embodiments, the second range of photon energies comprises gamma ray energies which are characteristic of one or more atomic nuclei of the wall 10 but does not comprise gamma ray energies which are not characteristic of at least one atomic nuclei of the wall 10.

The selected second range of photon energies is used in certain embodiments to specify which detected gamma rays are further analyzed. In certain embodiments, the second range of photon energies comprises one or more non-contiguous subranges which include the gamma ray peaks or spectral lines characteristic of one or more of the nuclei of the wall 10 being analyzed. Several factors can affect which gamma ray peaks are selected to be used for this analysis, including but are not limited to, gamma ray energy, cross-section, cascade versus photo-peak, proximity, overlay, and single and double escape peaks.

In certain embodiments, the selected second range of photon energies comprises only certain gamma ray energies within the first range of photon energies (e.g., 1.6 MeV to 7.2 MeV) corresponding to specific atomic nuclei within the wall 10. In certain embodiments, the cross-sections for the various nuclear reactions of the various atomic nuclei of the wall 10 are considered in this selection process. Certain embodiments advantageously select the second range of photon energies to include gamma ray energies corresponding to nuclear reactions which have higher probabilities (or higher cross-sections) of occurring.

In certain embodiments, cascade effects increase the number of possible photon energies to be selected for further analysis. Cascade effects are excitations of the nucleus to energy levels that do not drop directly to the lowest energy state. The initial excitation of the nucleus to higher energy levels generally produces more cascade peaks. As a result, cascade peaks are produced in the gamma ray energy spectrum from systematic transitions of the nucleus from excited energy states to intermediate energy states above the ground state. These cascade gamma rays have discrete energies which are characteristic of the particular nucleus involved in the nuclear reaction. Thus, certain embodiments seek to maximize count rate by selecting the second photon energy range to include cascade peak photon energies.

In certain embodiments, proximity of the gamma ray energy peaks emitted by the wall 10 influences the selected second range of photon energies. By using one or more gamma ray detectors 30 with increased energy resolution (e.g., solid-state germanium detector with an energy resolution of approximately 0.1% at 622 KeV), a 5.156 MeV gamma ray emitted by an aluminum nucleus can be discriminated from a 5.104 MeV gamma ray emitted by a nitrogen nucleus. Nal detectors have energy resolutions of roughly 10% at 722 KeV, so such detectors cannot discern between many peaks in the gamma ray energy spectrum. In certain embodiments, the second range of photon energies is selected so as to resolve various peaks of the gamma ray energy spectrum of the gamma rays emitted from the wall 10.

Certain gamma ray energy peaks from different elements overlap one another. For example, the carbon 4.440 MeV peak (with a width of approximately 100 keV) overlaps any other gamma ray peaks in this portion of the spectrum (e.g., the 4.411 MeV photo-peak of aluminum which has a cross-section of 4.9 millibarns). Such overlap contributes to errors in the analysis. Certain embodiments select the second range of photon energies to avoid overlapping gamma ray peaks from different elements. Furthermore, in certain embodiments in which the second range of photon energies includes multiple non-contiguous subsets of photon energies, each of which includes a gamma ray peak from a particular atomic nucleus, the amplitudes of these gamma ray peaks are compared with one another to determine the number of gamma rays from the particular atomic nucleus while reducing the effects of overlap in the analysis.

In certain embodiments, the production of single and double escape peaks influences the selected second range of photon energies. Certain gamma ray peaks are associated with additional peaks which are produced due to pair production by the gamma ray within the crystal lattice of the gamma ray detector 30. Pair production reduces the gamma ray energy by 511 keV (0.511 MeV). The amount of pair production is a function in part of the size of the gamma ray detector 30. The threshold energy for pair production is 1.022 MeV, and the cross-section for pair production is negligibly small for gamma rays with energies of only a couple of MeV, as compared to other processes such as ionization, bremmstahlung, etc. In certain embodiments, the energy of the gamma rays from delayed nuclear-decay processes are sufficiently small that pair production peaks are not an appreciable contribution to the delayed nuclear-decay gamma ray energy spectrum.

In certain embodiments, the number of detected gamma rays having photon energies within the selected range of photon energies is calculated, as indicated by the operational block 240 of FIG. 3. Certain embodiments utilize precise gamma ray energy determination to distinguish gamma rays emitted from nuclei of the wall 10 from other gamma rays, as described more fully below.

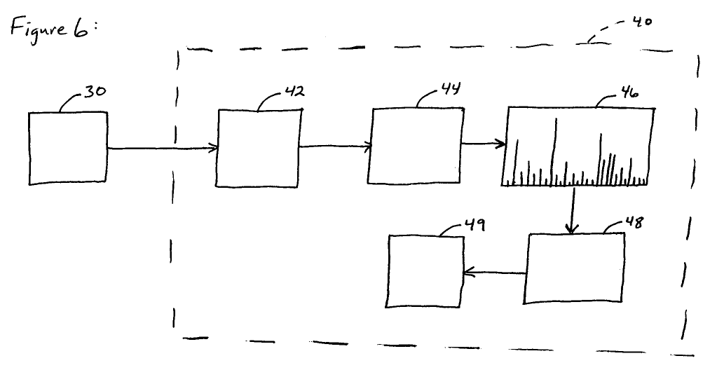

In certain embodiments, the gamma ray detector 30 generates analog signals which are indicative of the detected gamma rays and their photon energies. In certain embodiments, these analog signals are received by an analyzer 40 which comprises a discriminator 42, an analog-to-digital converter 44, and a histogram 46 comprising a plurality of channels, as schematically illustrated by FIG. 6. The discriminator 42 receives the analog signals from the gamma ray detector 30, and passes signals having a predetermined magnitude or higher to the analog-to-digital converter 44. In certain embodiments, the analog signals are shaped prior to being received by the discriminator 42. The analog-to-digital converter 44 outputs a digital signal with a value proportional to the height of the analog signal. This digital signal is received by the histogram 46. The histogram channel corresponding to the digital signal has its contents incremented by one in response to the digital signal. By integrating the number of detected gamma rays in the various channels in this way, certain embodiments provide a gamma ray emission spectrum as a function of the measured photon energy. In certain embodiments, the analyzer 40 integrates over a selected time period which allows sufficient counts to be included to reduce the signal-to-noise ratio due to statistical uncertainty. Persons skilled in the art are able to select an appropriate discriminator 42 and an analog-to-digital converter 44 from those readily available in the marketplace in accordance with embodiments described herein.

In certain embodiments, after the histogram 46 is populated with the digital gamma ray energy spectrum, the histogram 46 is then filtered by a digital filter 48 of the analyzer 40 and the filtered signals are stored in the random-access memory 49. The plurality of filtered signals corresponds to gamma ray peaks in the second range of photon energies. In certain embodiments, the signals corresponding to the detected gamma rays are electronically filtered to pass the spectral lines corresponding to the second range of photon energies and to exclude other spectral lines. The filtered signals include known spectral lines associated with selected atomic nuclei of the wall 10 (e.g., aluminum or maganese) and exclude other spectral lines not associated with selected nuclei of the wall 10. In certain embodiments, the filtered signals are stored in the random-access memory 49 to be accessed for further analysis. Persons skilled in the art are able to select an appropriate digital filter 48 and a random-access memory 49 from those readily available in the marketplace in accordance with embodiments described herein.

The detected gamma rays have a gamma ray emission spectrum with numerous spectral lines across the first range of photon energies from various contributions, as schematically illustrated by FIG. 6. Rather than analyzing the whole spectrum, certain embodiments described herein advantageously use only selected portions of the spectrum (e.g., the second range of photon energies) corresponding to selected atomic nuclei of the wall 10. The selected spectral lines can be changed based on the expected chemical composition of the wall 10 and of the contents of the conduit or container.

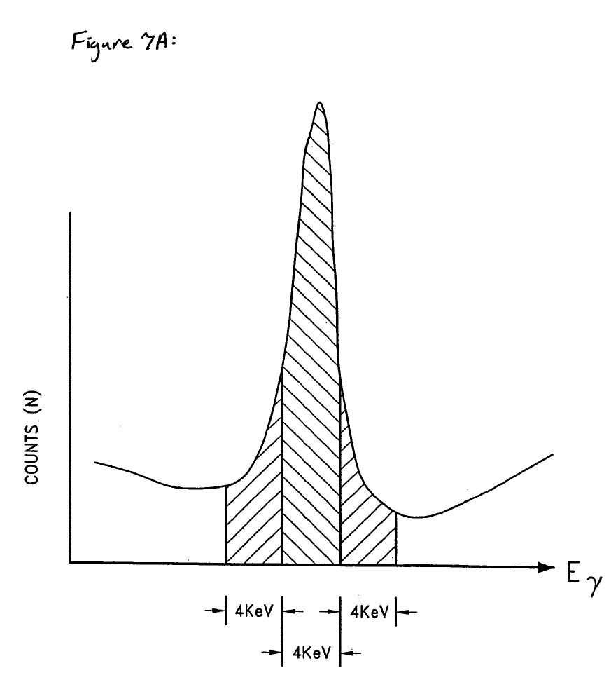

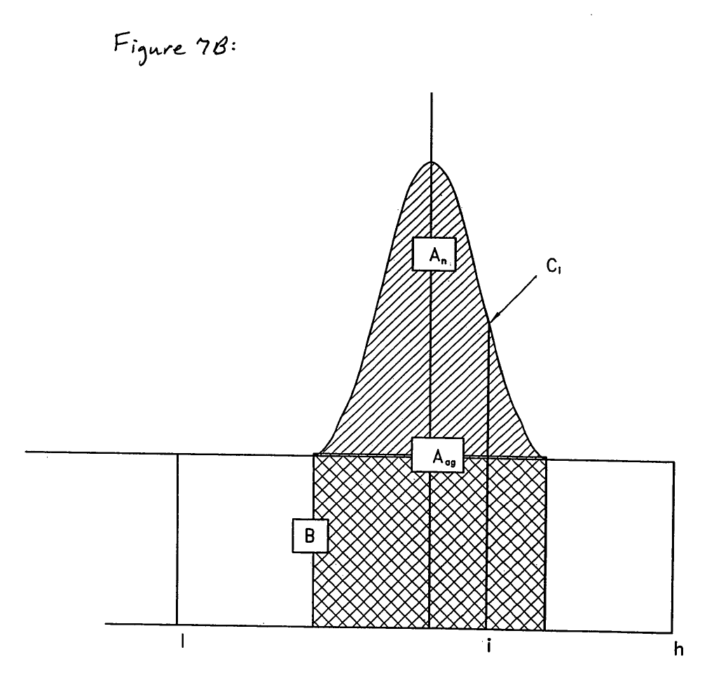

In certain embodiments, each gamma ray peak of the filtered signals is assigned one or more discrete binary values (“bins”) corresponding to photon energies of the gamma ray peak. For example, in certain embodiments, the amplitudes of each gamma ray peak in the second range of photon energies are divided into three equal 4 keV bandwidths within the gamma ray peak. These three bandwidths correspond to one “peak” bandwidth and two “shoulder” bandwidths, as schematically illustrated by FIG. 7A. The peak-to-shoulder amplitude difference(s) are used in certain such embodiments to determine the amplitude of the peak for purposes of further analysis.

Certain embodiments quantitatively subtract background contributions from the peaks of the filtered signal, as schematically illustrated by FIG. 7B. The regions of interest (ROI) for background subtraction depend on the identity of the interrogated material and are advantageously selected to overlap with the specific gamma ray spectral lines of the atomic nuclei of the wall 10. An exemplary background subtraction method compatible with certain embodiments described herein is outlined below, but other background subtraction methods may also be used.

In certain embodiments, the background subtraction comprises calculating the background contribution of the peak area. The background level for the lower-energy side of the peak is calculated as the average contents of the first three channels of the ROI. The channel number for this background level is the middle channel of these first three channels. The background level for the higher-energy side of the peak is calculated as the average contents of the last three channels of the ROI. The channel number for this background level is the middle channel of these last three channels. In certain embodiments, a straight-line background level is calculated by interpolating between the background levels for the lower-energy side and the higher-energy side. Hence, the background area B of the peak is given by the following:

$$B = ( {\sum }_{i = l}^{l + 2} {C}_{i} + {\sum }_{i = h - 2}^{h} {C}_{i} ) \frac{h - l + 1}{6}$$

where
l=the channel number of the lower-energy side of the peak;
h=the channel number of the higher-energy side of the peak;
Cᵢ=the contents of channel i; and
6=the number of data channels used (which is 3 on each side of the peak in this exemplary embodiment).

The gross area A_{g} of the peak is the sum of all the contents or counts in the channels within the ROI, given by:

$${A}_{g} = {\sum }_{i = l}^{h} {C}_{i} .$$

The adjusted gross area A_{ag} is the sum of all of the counts in the channels within the ROI excluding those channels used to determine the background levels of the lower-energy side and the higher-energy side of the peak, given by:

$${A}_{ag} = {\sum }_{i = l + 3}^{h - 3} {C}_{i} .$$

The net adjusted area Aₙ of the peak can then be calculated to be given by:

$${A}_{n} = {A}_{ag} - \frac{B ( h - l - 5 )}{( h - l + 1 )} .$$

The error in the net adjusted area Aₙ of the peak in certain embodiments is the square root of the sum of the squares of the error in the adjusted gross area A_{ag} and the weighted error of the adjusted background. The background error in certain embodiments is weighted by the ratio of the adjusted peak width to the number of the channels used to calculate the adjusted background.

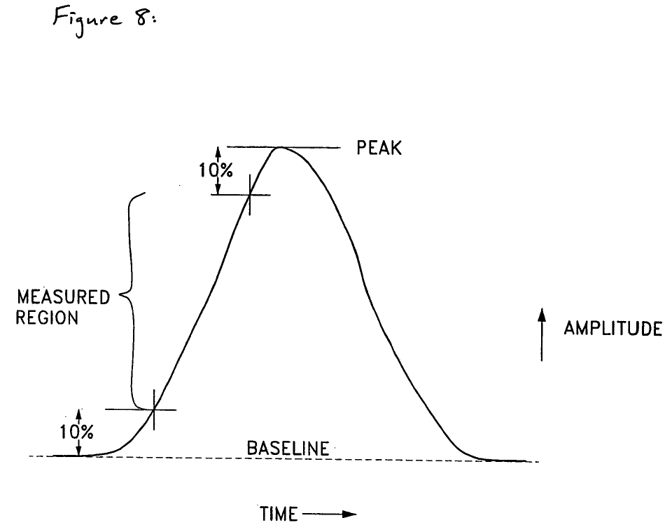

Solid-state germanium detectors characteristically have a slower response time than other types of gamma ray detectors (such as sodium iodide crystal), thereby having a correspondingly lower temporal resolution. For example, in certain embodiments, an HPGD can process a maximum event rate (including random events) on the order of 50,000 counts/second. In certain embodiments, this slower response rate is compensated for by the analyzer 40 through the use of electronic processing of the signals from the gamma ray detector 30 which effectively reduces the response time constant. In certain embodiments, that portion of the HPGD signal corresponding to a fraction of the rise time of the gamma event is used to determine the time resolution. This rise time is typically in the range of 1.5 to 4 nanoseconds, and is measured from a point 10% above the baseline prior to the event to a point 10% below the peak value of the event, as schematically illustrated in FIG. 8. The rise time signal processing is accomplished in certain embodiments by using a constant fraction discriminator (CFD). Persons skilled in the signal processing and nuclear detection arts can select an appropriate constant fraction discriminator compatible with embodiments described herein.

Charge collection in certain embodiments is further stopped electronically (“gated”) to reduce the charge collection time or “dead time” of the detector. In certain embodiments, the charge collection time is gated at 20 nanoseconds. In certain such embodiments, the effective maximum count rate of the HPGD is substantially increased, since the charge collection time of the detector is reduced, and temporal resolution increased. In certain embodiments in which gamma rays from the delayed nuclear-decay process are detected after turning off, removing, or otherwise deactivating the neutron beam, the gamma ray count rate is on the order of approximately 10,000 counts per second. Such count rates are advantageously detected using standard, off-the-shelf electronic components which can handle these count rates with less than 5% deadtime.

Upon calculating the number of delayed gamma rays in at least one peak of the gamma ray energy spectrum, the analyzer 40 then uses this data to determine the thickness of the irradiated portion of the wall 10, as indicated by the operational block 250 of FIG. 3. In certain embodiments, the analyzer 40 uses a previously-determined relationship between the thickness of the wall 10 to the number of delayed gamma rays in a spectral peak characteristic of an atomic nucleus of the wall 10 to translate the gamma ray emission data to a wall thickness determination. For example, FIG. 5 provides a relationship between the number of counts per second of delayed gamma rays in the 847 keV peak (corresponding to the decay of Mn-56 nuclei with a half-life of approximately 2.6 hours) and the wall thickness which can be used in certain embodiments to translate the gamma ray emission data to a wall thickness determination. Other method of determining the wall thickness using the calculated number of detected gamma rays are also compatible with embodiments described herein.

In certain embodiments, the wall 10 has a known initial wall thickness and undergoes erosion which reduces the thickness of the wall from the initial wall thickness. In certain embodiments, the measured wall thickness is compared to the initial wall thickness and the amount of erosion is determined by calculating a difference between the known initial wall thickness and the measured wall thickness.

By using energy discrimination, certain embodiments advantageously examine the thickness of the wall 10 independent of the material filling the volume defined by the wall 10. For example, in certain embodiments, the wall 10 is part of a fluid vessel, such as an oil pipeline substantially filled with oil. By examining only gamma ray peaks corresponding to nuclei found in the wall 10 and not in the oil, certain embodiments provide the wall thickness independent of the contents of the pipeline.

In certain embodiments, the entire length and periphery of the walls 10 of a vessel (e.g., tubular conduit such as an oil pipeline or a container) are thoroughly scanned using the apparatus 100 to detect and locate internal depressions, erosions, or wall thinnings which may eventually result in catastrophic perforations of the wall 10. This scanning can advantageously be done wholly externally to the wall 10, thereby allowing the vessel to remain in service during the scanning. Certain embodiments advantageously externally detect internal weakened flaws in the walls of the vessel long before the wall 10 experiences catastrophic rupture.

Various embodiments of the present invention have been described above. Although this invention has been described with reference to these specific embodiments, the descriptions are intended to be illustrative of the invention and are not intended to be limiting. Various modifications and applications may occur to those skilled in the art without departing from the true spirit and scope of the invention as defined in the appended claims.

1. A method of measuring a thickness of a wall, the method comprising:
irradiating at least a portion of the wall with a plurality of 14-MeV neutrons, the wall emitting gamma rays with photon energies characteristic of the atomic nuclei in response thereto;
detecting at least a portion of the gamma rays emitted from the wall and measuring the photon energies of the detected gamma rays with an energy resolution better than approximately 0.5%, the detected gamma rays having a first range of photon energies;
selecting a second range of photon energies which is a subset of the first range of photon energies;
calculating a number of detected gamma rays having measured photon energies within the selected second range of photon energies; and
determining the wall thickness using the calculated number of detected gamma rays.

2. A method of measuring a thickness of a wall, the method comprising:
irradiating at least a portion of the wall with a plurality of neutrons, the wall emitting gamma rays with photon energies characteristic of the atomic nuclei in response thereto;
detecting at least a portion of the gamma rays emitted from the wall and measuring the photon energies of the detected gamma rays, the detected gamma rays having a first range of photon energies;
selecting a second range of photon energies which is a subset of the first range of photon energies;
calculating a number of detected gamma rays having measured photon energies within the selected second range of photon energies; and
determining the wall thickness using the calculated number of detected gamma rays.

3. The method of claim 2, wherein the atomic nuclei absorb neutrons and emit delayed nuclear-decay gamma rays.

4. The method of claim 2, wherein the neutrons have energies approximately equal to 14 MeV.

5. The method of claim 2, wherein the neutrons are generated by a fast neutron emitter source.

6. The method of claim 2, wherein the neutrons are generated by a deuterium-tritium reaction.

7. The method of claim 2, wherein the wall comprises concrete or cement.

8. The method of claim 2, wherein the wall comprises a pipe wall.

9. The method of claim 2, wherein the wall has a known initial wall thickness greater than the determined wall thickness, the method further comprising determining an amount of erosion of the wall by calculating a difference between the known initial wall thickness and the determined wall thickness.

10. The method of claim 2, wherein detecting the gamma rays comprises using a solid-state germanium detector.

11. The method of claim 10, wherein the solid-state germanium detector has an energy resolution better than 0.5%.

12. The method of claim 10, wherein the solid-state germanium detector has an energy resolution better than 0.3%.

13. The method of claim 2, wherein the neutrons are directed at the wall from a first side of the wall and gamma rays are detected from the first side of the wall.

14. The method of claim 2, wherein the neutrons are directed at the wall from a first side of the wall and gamma rays are detected from a second side of the wall.

15. The method of claim 2, wherein irradiating at least a portion of the wall with a plurality of neutrons comprises generating a plurality of neutron/alpha particle pairs from a target, each pair comprising a neutron and a corresponding alpha particle propagating in substantially opposite directions, the neutrons propagating toward the wall, the alpha particles propagating away from the wall.

16. The method of claim 2, wherein the gamma rays are emitted from nuclei of aluminum or maganese.

17. The method of claim 2, wherein the gamma rays are emitted from nuclei which, upon absorbing neutrons, become radioisotope nuclei which decays thereby emitting the gamma rays.

18. A method for measuring a thickness of a wall, the method comprising:
positioning a source of neutrons in proximity to the wall;
directing the neutrons at the wall, the neutrons causing the wall to emit gamma rays with photon energies characteristic of atomic nuclei within the wall;
detecting at least a portion of the gamma rays;
determining a photon energy distribution of the detected gamma rays; and
calculating the thickness of the wall from a subset of the photon energy distribution of the detected gamma rays.

19. The method of claim 18, wherein detecting at least a portion of the gamma rays comprises positioning a gamma ray detector in proximity to the wall.

20. The method of claim 19, wherein the gamma ray detector comprises a germanium detector.

21. The method of claim 20, wherein the germanium detector has an energy resolution better than 0.5%.

22. The method of claim 20, wherein the germanium detector has an energy resolution better than 0.3%.

23. The method of claim 18, wherein calculating the thickness of the wall comprises calculating a number of detected gamma rays having photon energies within the subset of the photon energy distribution.

24. The method of claim 18, wherein directing the neutrons at the wall comprises generating a plurality of neutron/alpha particle pairs from a target in the source, each pair comprising a neutron and a corresponding alpha particle propagating in substantially opposite directions, the neutrons propagating toward the wall, the alpha particles propagating away from the wall.

25. The method of claim 18, wherein the gamma rays are emitted from nuclei of aluminum or maganese.

26. The method of claim 18, wherein the gamma rays are emitted from nuclei which, upon absorbing a neutron, become a radioisotope nucleus which decays thereby emitting a gamma ray.

27. The method of claim 18, wherein the wall comprises concrete or cement.

28. The method of claim 18, wherein the wall is a portion of an above-ground structure.

29. The method of claim 28, wherein the structure comprises an oil pipeline.

30. The method of claim 18, wherein the wall has a known initial wall thickness greater than the determined wall thickness, and the method further comprises determining an amount of erosion of the wall by calculating a difference between the known initial wall thickness and the determined wall thickness.

31. The method of claim 18, wherein the energy of the neutrons is approximately equal to 14 MeV.

32. The method of claim 18, wherein the neutrons are generated by a deuterium-tritium reaction.
